(19) United States
(12) Patent Application Publication
(10) Pub. No.: US 2013/0290243 A1
(43) Pub. Date: Oct. 31, 2013

(54) METHOD AND SYSTEM FOR TRANSACTION REPRESENTATION IN APPEND-ONLY DATASTORES

(71) Applicant: CLOUDTREE, INC., Waltham, MA (US)

(72) Inventors: Thomas HAZEL, Andover, MA (US); Jason P. Jeffords, Bedford, NH (US); Gerard L. Buteau, Durham, NH (US)

(73) Assignee: Cloudtree, Inc., Waltham, MA (US)

(21) Appl. No.: 13/829,213

(22) Filed: Mar. 14, 2013

Related U.S. Application Data
(60) Provisional application No. 61/638,886, filed on Apr. 26, 2012.

(51) Int. Cl. G06F 17/30

(52) U.S. Cl. CPC G06F 17/30377
USPC 707/607

(57) ABSTRACT

A method, apparatus, and system, and computer program product for transaction representation in append-only data-stores. The system receives input from a user or agent and begins a transaction involving at least one datastore based on the received input. The system then creates, updates, and maintains a transaction state. The system ends the transaction and writes the state of the transaction to memory in an append-only manner, wherein the state comprises append-only key and value files.

### CLAIM OF PRIORITY UNDER 35 U.S.C. §119

The present application for patent claims priority to Provisional Application No. 61/638,886 entitled “METHOD AND SYSTEM FOR TRANSACTION REPRESENTATION IN APPEND-ONLY DATASTORES” filed Apr. 26, 2012, the entire contents of which are hereby expressly incorporated by reference herein.

### REFERENCE TO CO-PENDING APPLICATIONS FOR PATENT

The present application for patent is related to the following co-pending U.S. patent applications:
U.S. patent application Ser. No. 13/781,339, entitled “METHOD AND SYSTEM FOR APPEND-ONLY STORAGE AND RETRIEVAL OF INFORMATION” filed Feb. 28, 2013, which claims priority to Provisional Application No. 61/604,311 entitled “METHOD AND SYSTEM FOR APPEND-ONLY STORAGE AND RETRIEVAL OF INFORMATION” filed Feb. 28, 2012, the entire contents of both of which are expressly incorporated by reference herein; and
Provisional Application No. 61/613,830 entitled “METHOD AND SYSTEM FOR INDEXING IN DATASTORES” filed Mar. 21, 2012, the entire contents of which are expressly incorporated by reference herein.

### BACKGROUND

1. Field

The present disclosure relates generally to a method, apparatus, system, and computer readable media for representing transactions in append-only datastores, and more particularly for representing transactions both on-disk and in-memory.

2. Background

Traditional datastores and databases are designed with log files and paged data and index files. Traditional designs store operations and data in log files and then move this information to paged database files, e.g., by reprocessing the operations and data. This approach has many weaknesses or drawbacks, such as the need for extensive error detection and correction when paged files are updated in place, the storage and movement of redundant information and the disk seek bound nature of in-place page updates.

### SUMMARY

In light of the above described problems and unmet needs as well as others, systems and methods are presented for providing direct representation of transactions both in-memory and on-disk. This is accomplished using a state collapse method, wherein the end state of a transaction is represented in-memory and written to disk upon commit.

For example, aspects of the present invention provide advantages such as streamlined and pipelined transaction processing, greatly simplified error detection and correction including transaction roll-back and efficient use of storage resources by eliminating traditional logging and page files containing redundant information and replacing them with append-only transaction end state files and associated index files.

Additional advantages and novel features of these aspects of the invention will be set forth in part in the description that follows, and in part will become more apparent to those skilled in the art upon examination of the following or upon learning by practice thereof.

### BRIEF DESCRIPTION OF THE DRAWINGS

Various aspects of the systems and methods will be described in detail, with reference to the following figures, wherein:

FIG. 1 presents an example system diagram of various hardware components and other features, for use in accordance with aspects of the present invention;

FIG. 2 is a block diagram of various example system components, in accordance with aspects of the present invention;

FIG. 3 illustrates a flow chart with aspects of transaction representation in append-only datastores in accordance with aspects of the present invention;

FIG. 4 illustrates a flow chart with aspects of an example automated method of receiving a begin transaction request and starting a new transaction, in accordance with aspects of the present invention;

FIG. 5 illustrates a flow chart with aspects of an example automated method of receiving a prepare transaction request, writing a prepare indication to a memory buffer, and performing prepare operations, in accordance with aspects of the present invention;

FIG. 6 illustrates a flow chart with aspects of an example automated method of committing a transaction across associated datastores, in accordance with aspects of the present invention;

FIG. 7 illustrates a flow chart with aspects of an example automated method of aborting a transaction, in accordance with aspects of the present invention;

FIG. 8 illustrates a flow chart with aspects of an example automated method of associating a datastore with a transaction, in accordance with aspects of the present invention;

FIG. 9 illustrates a flow chart with aspects of an example automated method of preparing a datastore for transaction commit, in accordance with aspects of the present invention;

FIG. 10 illustrates a flow chart with aspects of an example automated method of updating an in-memory state of a datastore, in accordance with aspects of the present invention;

FIG. 11 illustrates a flow chart with aspects of an example automated method of rewinding a datastore's LRT and VRT file write cursors, in accordance with aspects of the present invention;

FIG. 12 illustrates a flow chart with aspects of an example automated method of incrementing a transaction level, in accordance with aspects of the present invention;

FIG. 13 illustrates a flow chart with aspects of an example automated method of releasing a save point within associated datastores, in accordance with aspects of the present invention;

FIG. 14 illustrates a flow chart with aspects of an example automated method of processing a nesting level change indication, in accordance with aspects of the present invention;

FIG. 15 illustrates a flow chart with aspects of an example automated method of rolling back that transaction across associated datastores, in accordance with aspects of the present invention;

FIG. 16 illustrates a flow chart with aspects of an example automated method of processing a commit transaction request when transaction streamlining with synchronous IO is enabled, in accordance with aspects of the present invention;

FIG. 17 illustrates a flow chart with aspects of an example automated method of processing a commit transaction request when transaction streamlining with asynchronous IO is enabled, in accordance with aspects of the present invention;

FIG. 18 illustrates a flow chart with aspects of an example automated method of processing a commit transaction request when transaction pipelining with synchronous IO is enabled, in accordance with aspects of the present invention;

FIG. 19 illustrates a flow chart with aspects of an example automated method of processing a commit transaction request when transaction pipelining with asynchronous IO is enabled, in accordance with aspects of the present invention;

FIG. 20 illustrates aspects of an example two phase commit FSM, in accordance with aspects of the present invention;

FIG. 21 illustrates aspects of example valid key/value state transitions within a single transaction, in accordance with aspects of the present invention;

FIG. 22 illustrates aspects of an example group delineation in LRT files, in accordance with aspects of the present invention;

FIG. 23 illustrates aspects of an example logical layout of a transaction log entry, in accordance with aspects of the present invention;

FIG. 24 illustrates aspects of an example transaction log spanning two files, in accordance with aspects of the present invention;

FIG. 25 illustrates aspects of an example transaction streamlining with synchronous IO, in accordance with aspects of the present invention;

FIG. 26 illustrates aspects of an example transaction streamlined with asynchronous IO, in accordance with aspects of the present invention;

FIG. 27 illustrates aspects of an example transaction pipelining with synchronous IO, in accordance with aspects of the present invention; and

FIG. 28 illustrates aspects of example transaction pipelining with asynchronous IO, in accordance with aspects of the present invention.

### DETAILED DESCRIPTION

These and other features and advantages in accordance with aspects of this invention are described in, or will become apparent from, the following detailed description of various example illustrations and implementations.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of systems capable of providing representations of transactions for both disk and memory, in accordance with aspects of the present invention will now be presented with reference to various apparatuses and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented using a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more example illustrations, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), Electrically Erasable Programmable ROM (EEPROM), compact disk (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

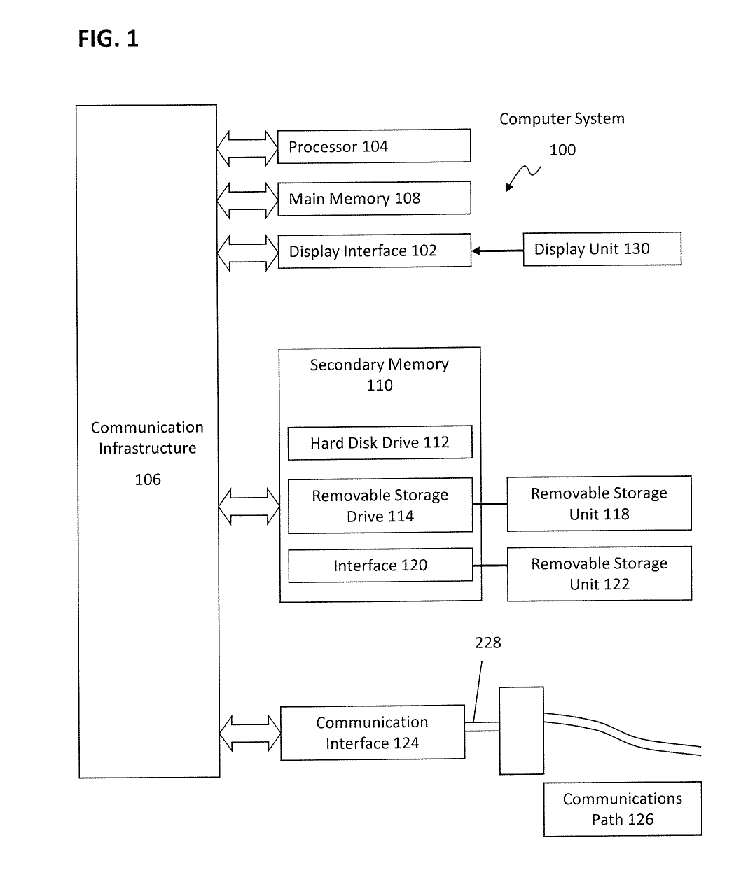

FIG. 1 presents an example system diagram of various hardware components and other features, for use in accordance with an example implementation in accordance with aspects of the present invention. Aspects of the present invention may be implemented using hardware, software, or a combination thereof, and may be implemented in one or more computer systems or other processing systems. In one implementation, aspects of the invention are directed toward one or more computer systems capable of carrying out the functionality described herein. An example of such a computer system 100 is shown in FIG. 1.

Computer system 100 includes one or more processors, such as processor 104. The processor 104 is connected to a communication infrastructure 106 (e.g., a communications bus, cross-over bar, or network). Various software implementations are described in terms of this example computer system. After reading this description, it will become apparent to a person skilled in the relevant art(s) how to implement aspects of the invention using other computer systems and/or architectures.

Computer system 100 can include a display interface 102 that forwards graphics, text, and other data from the communication infrastructure 106 (or from a frame buffer not shown) for display on a display unit 130. Computer system 100 also includes a main memory 108, preferably RAM, and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc., which is read by and written to removable storage drive 114. As will be appreciated, the removable storage unit 118 includes a computer usable storage medium having stored therein computer software and/or data.

In alternative implementations, secondary memory 110 may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an EPROM, or programmable read only memory (PROM)) and associated socket, and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of signals 128, which may be electronic, electromagnetic, optical or other signals capable of being received by communications interface 124. These signals 128 are provided to communications interface 124 via a communications path (e.g., channel) 126. This path 126 carries signals 128 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 114, a hard disk installed in hard disk drive 112, and signals 128. These computer program products provide software to the computer system 100. Aspects of the invention are directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features in accordance with aspects of the present invention, as discussed herein. In particular, the computer programs, when executed, enable the processor 110 to perform various features. Accordingly, such computer programs represent controllers of the computer system 100.

In an implementation where aspects of the invention are implemented using software, the software may be stored in a computer program product and loaded into computer system 100 using removable storage drive 114, hard drive 112, or communications interface 120. The control logic (software), when executed by the processor 104, causes the processor 104 to perform various functions as described herein. In another implementation, aspects of the invention are implemented primarily in hardware using, for example, hardware components, such as application specific integrated circuits (ASICs). Implementation of the hardware state machine so as to perform the functions described herein will be apparent to persons skilled in the relevant art(s).

In yet another implementation, aspects of the invention are implemented using a combination of both hardware and software.

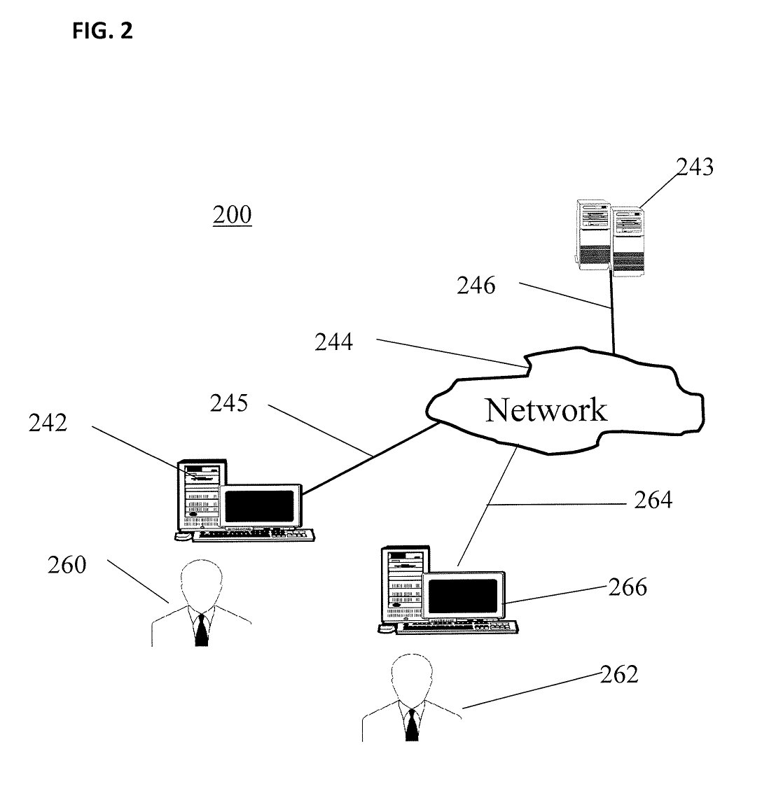

FIG. 2 is a block diagram of various example system components, in accordance with aspects of the present invention. FIG. 2 shows a communication system 200 usable in accordance with the aspects presented herein. The communication system 200 includes one or more accessors 260, 262 (also referred to interchangeably herein as one or more “users” or clients) and one or more terminals 242, 266. In an implementation, data for use in accordance with aspects of the present invention may be, for example, input and/or accessed by accessors 260, 264 via terminals 242, 266, such as personal computers (PCs), minicomputers, mainframe computers, microcomputers, telephonic devices, or wireless devices, such as personal digital assistants (“PDAs”) or a hand-held wireless devices coupled to a server 243, such as a PC, minicomputer, mainframe computer, microcomputer, or other device having a processor and a repository for data and/or connection to a repository for data, via, for example, a network 244, such as the Internet or an intranet, and couplings 245, 246, 264. The couplings 245, 246, 264 include, for example, wired, wireless, or fiberoptic links.

When information is naturally ordered during creation, there is no need for a separate index, or index file, to be created and maintained. However, when information is created in an unordered manner, anti-entropy algorithms may be required to restore order and increase and lookup performance.

Anti-entropy algorithms, e.g., indexing, garbage collection, and defragmentation, help to restore order to an unordered system. These operations may be parallelizable. This enables the operations to take advantage of idle cores in multi-core systems. Thus, read performance is regained at the expense of extra space and time, e.g., disk indexes and background work.

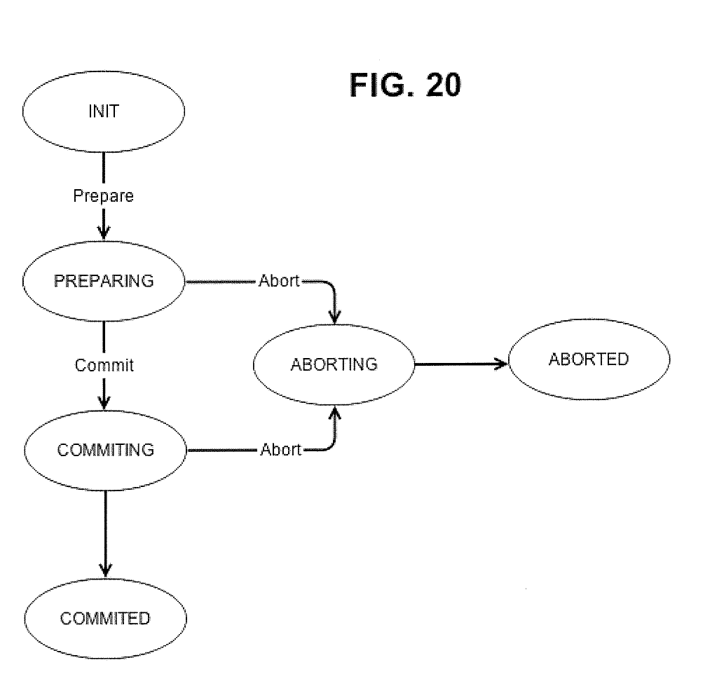

Over time, append-only files may become large. Files may need to be closed and/or archived. In this case, new Real Time Key Logging (LRT) files, Real Time Value Logging (VRT) files, and Real Time Key Tree Indexing (IRT) files can be created, and new entries may be written to these new files. An LRT file may be used to provide key logging and indexing for a VRT file. An IRT file may be used to provide an ordered index of VRT files. LRT, VRT, and IRT files are described in more detail in U.S. Utility application Ser. No. 13/781,339, filed on Feb. 28, 2013, titled “Method and System for Append-Only Storage and Retrieval of Information, which claims priority to U.S. Provisional Application No. 61/604,311, filed on Feb. 28, 2012” the entire contents of both of which are incorporated herein by reference. Forming an index requires an understanding of the type of keying and how the files are organized in storage, e.g., how the on-disk index files are organized. An example logical illustration of file layout and indexing with an LRT file, VRT file, and IRT file is shown in FIG. 20A-20B in this reference.

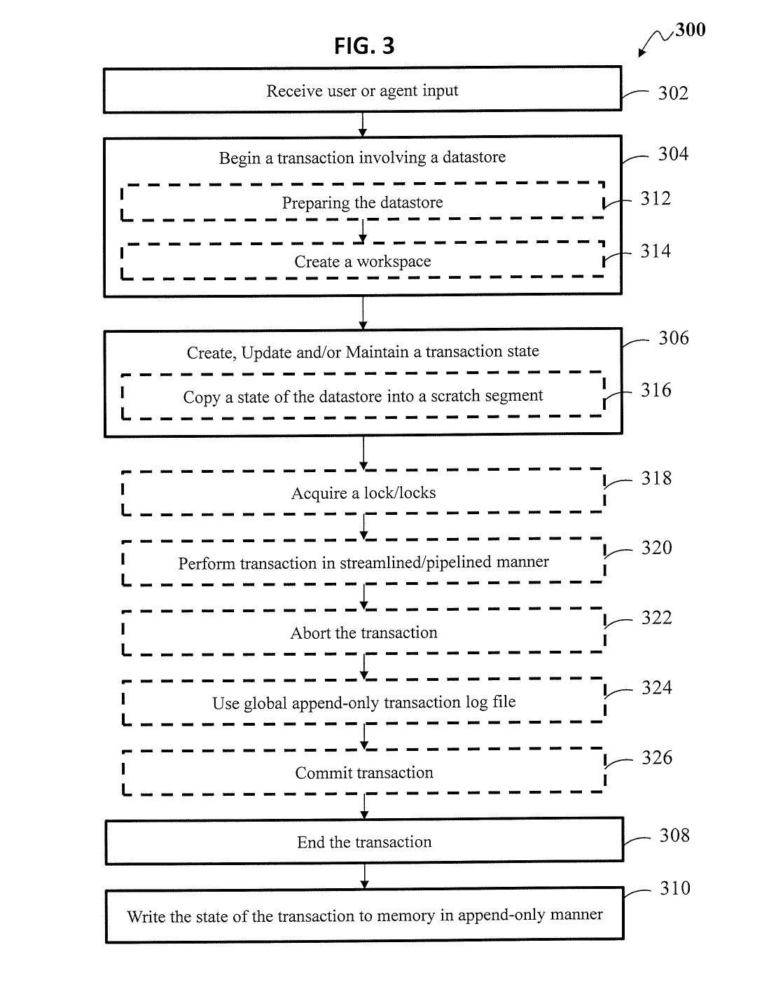

FIG. 3 presents a flow chart illustrating aspects of an automated method 300 of transaction representation in append-only data-stores. Optional aspects are illustrated using a dashed line. At 302, input is received. This may be either user input or agent input. User input may be received, e.g., via a user interface. Such user input may include information and operations that must occur atomically and once and only once or not at all, e.g., the submittal of an order to an online store.

At 304, a transaction is begun, the transaction involving at least one datastore based on user or agent input. Beginning a transaction may include, e.g., accessing at least one key/value pair within a datastore.

The datastore involved in the transaction may be prepared, as at 312. Preparing a datastore may include appending a begin prepare transaction indication to the global transaction log when the prepare begins, acquiring a prepare lock for each datastore involved in the transaction, and appending an end prepare transaction indication to the global transaction log when the prepare ends. The begin prepare transaction indication and the end prepare transaction indication may identify, e.g., the transaction being prepared.

In addition, a workspace may be created at 314, the workspace including a user space context and a scratch segment maintaining key to information bindings. Transaction levels may be maintained. In an example, as transactions may be nested, transactions levels may be maintained, e.g., increased each time a new nested transaction is started and decreased each time a nested transaction is aborted or committed.

At 306, at least one of creation, maintenance, and update of a transaction state is performed. This may include copying a state of the datastore into a scratch segment at 316. The scratch segment may be updated throughout the transaction. Creating, updating, and/or maintaining the transaction state may include, e.g., using transaction save points, transaction restore points, and/or transaction nesting. Transaction save points may enable, e.g., a transaction to roll back operations to any save point without aborting the entire transaction. Transaction save points may be released with their changes being preserved. Transaction nesting may create, e.g., implicit save points. Thus, rolling back a nested transaction may not roll back the nesting transaction, and a rollback all operation may roll back both nested and nesting transactions.

The transaction is ended at 308, and the state of the transaction is written to memory in an append-only manner at 310, wherein the state comprises append-only key and value files. The append-only key and values files may, e.g., encode at least one boundary that represents the transaction. The append-only key and values files may represent, e.g., an end state of the transaction. For example, the state written to memory may be an end state of the scratch segment after the transaction has ended. The memory to which the state of the transaction is written may be non-transient, e.g., disk memory. Append-only transaction log files may group a plurality of files representing the transaction.

Key/value pairs may be considered modified when the key/value pair is created, updated, or deleted.

At 318, at least one lock may be acquired. For example, a lock for a segment in the transaction may be acquired. A read lock for a key/value pair read in the transaction may be acquired. Additionally, a write lock for a key/value pair modified in the transaction may be acquired. Locks may be acquired in order, and lock acquisition order may be maintained. Locks may be acquired in a consistent order, e.g., in order to avoid deadlocks.

A read lock may be promoted to a write lock when only one reader holds the read lock and when the reader needs to modify key/value pairs, e.g., in order to enable the reader to modify the key/value pairs. A reader in this case refers to the entity reading the key/value pair. The system may, e.g., promote a read lock to a write lock if that reader/entity is the exclusive holder of the read lock when it tries to modify the key/value pair.

The transaction state may be written to each datastore in an append-only manner after all datastore prepare locks have been acquired. VRT files may be appended before LRT files are appended.

Any acquired lock may be released when the transaction is ended. The locks may be released, e.g., in acquisition order.

As illustrated at 320, the transaction may be performed in a streamlined manner, or, the transaction may be performed in a pipelined manner, as described in more detail below. IO may be either synchronous or asynchronous. Transaction streamlining may comprise, e.g., a single-threaded, zero-copy, single-buffered method. Transaction streamlining may minimize per-transaction latency. Transaction pipelining may comprise a multi-threaded, double-buffered method. Transaction pipelining may maximize transaction throughput.

At 322, the transaction may be aborted. During the prepare state, this may include releasing all associated prepare locks in a consistent acquisition order. The transaction state may be written to a VRT file and/or a LRT file, wherein the transaction state is either rolled back or identified with an append-only erasure indication. An abort transaction indication may be appended to a global transaction log, the abort transaction indication indicating the transaction aborted. Aborting the transaction may include releasing any acquired segment and key/value locks in acquisition order.

At 324, a global append-only transaction log file may be used. Flags may be used, e.g., to indicate a transaction state. Such flags may represent any of a begin prepare transaction, an end prepare transaction, a commit transaction, an abort transaction, and no outstanding transactions. A no outstanding transactions flag may be used as a checkpoint enabling fast convergence of error recovery algorithms.

Transactions and/or files may be identified by UUIDs. Transactions may, e.g., be distributed. A time stamp may be used in order to record a transaction time. Such timestamps may comprise either wall clock time, e.g., UTC, or time measured in ticks, e.g., Lamport timestamp.

At 326, the transaction may be committed. Committing the transaction may cause the transaction to be prepared and may follow a successful transaction preparation. A commit transaction indication may be appended to a global transaction log, the commit transaction indication indicating the transaction committed. Committing the transaction may include releasing any acquired segment and key/value locks in acquisition order.

In an aspect the steps described in connection with FIG. 3 may be performed, e.g., by a processor, such as 104 in FIG. 1.

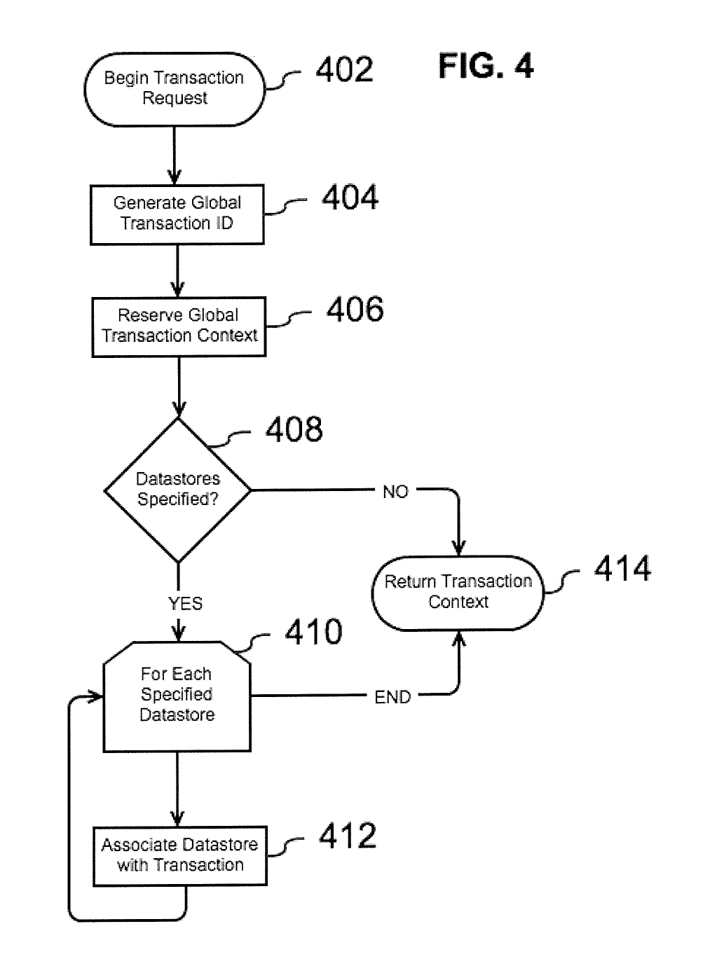

FIG. 4 is a flow chart illustrating aspects of an example automated method 400 of receiving a begin transaction request in 402 and starting a new transaction. At 404 a new, unique global transaction ID is generated to identify the transaction and at 406 a global transaction context is reserved. If datastores are specified as determined at 408 each specified datastore is traversed in 410 and associated with the transaction at 412. Once all datastores have been traversed in 410, or if no datastores were specified in 408, the transaction context is returned in 414.

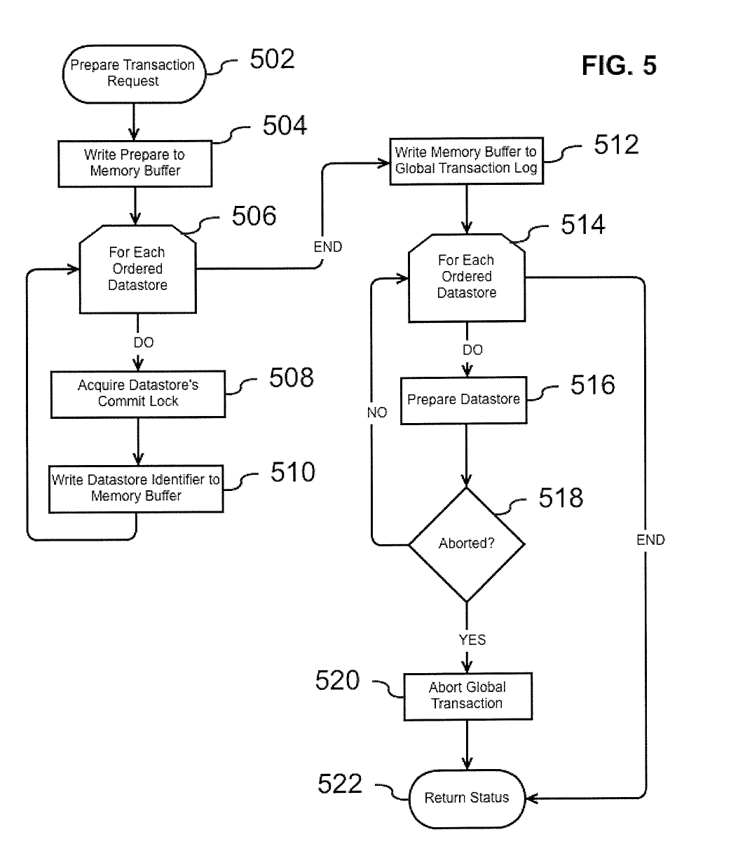

FIG. 5 is a flow chart illustrating aspects of an example automated method 500 of receiving a prepare transaction request at 502, writing a prepare indication to a memory buffer at 504 and performing prepare operations across all ordered datastores associated with the transaction starting at 506. For example, a next step in the prepare operation may be to acquire each associated datastore's commit lock by iterating over each ordered datastore in 506, acquiring each datastore's commit lock at 508 and writing the datastore's identifier to the memory buffer at 510. Once all associated datastore commit locks are acquired and all datastore identifiers are written to the memory buffer the iteration ends and the memory buffer representing the global transaction is written to the global transaction log at 512.

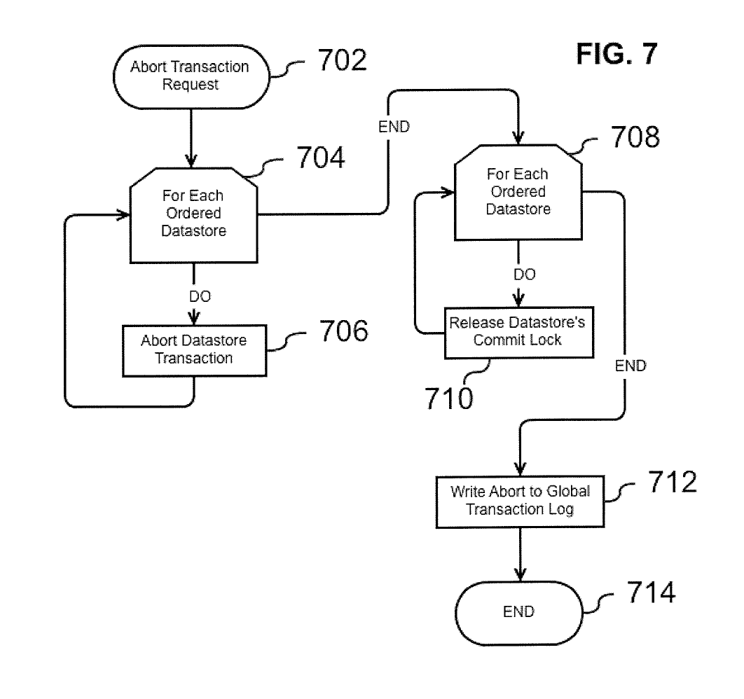

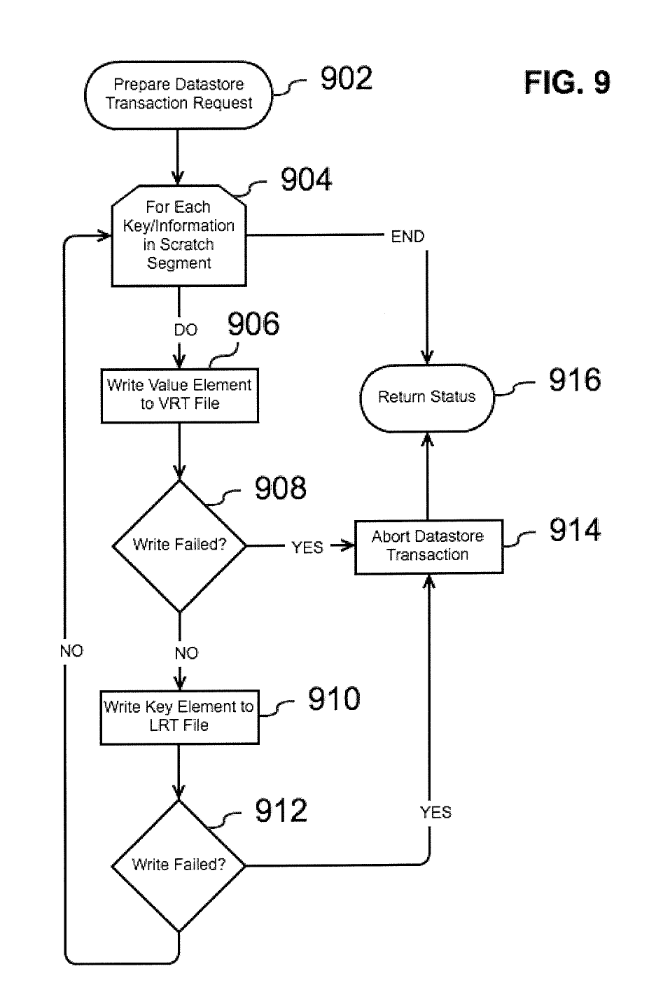

Next, each ordered datastore is iterated over in 514 and each datastore is prepared in 516. Additional details are described in connection with FIG. 9. If the datastore prepare is not aborted as determined at 518 the next ordered datastore is iterated over in 514. If the datastore prepare aborts as determined at 518 the entire global transaction is aborted at 520, additional details are described in connection with FIG. 7, and an aborted status is returned at 522. If all datastores are successfully prepared the iteration at 514 ends and a success status is returned at 522.

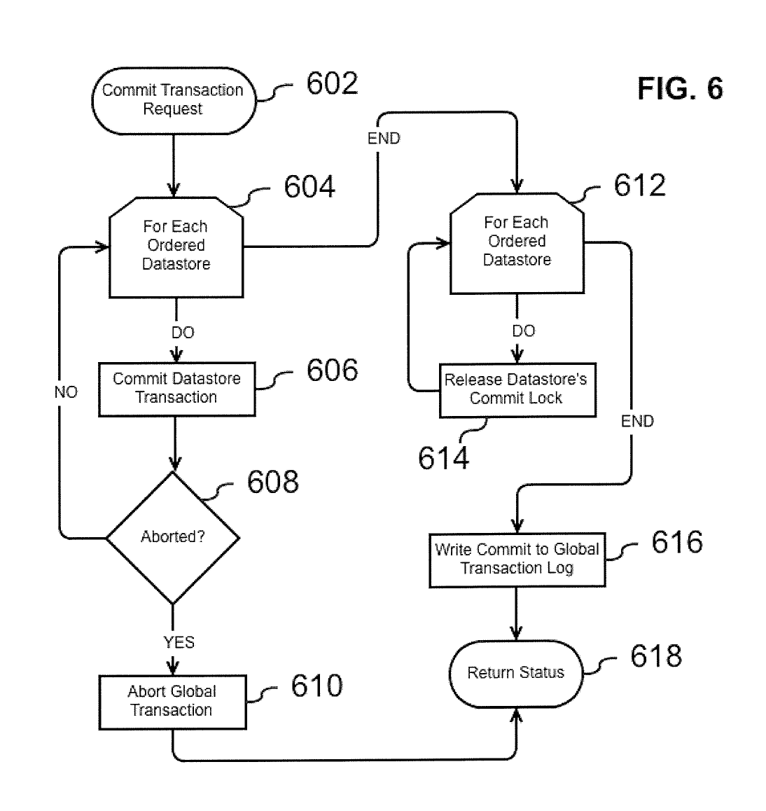

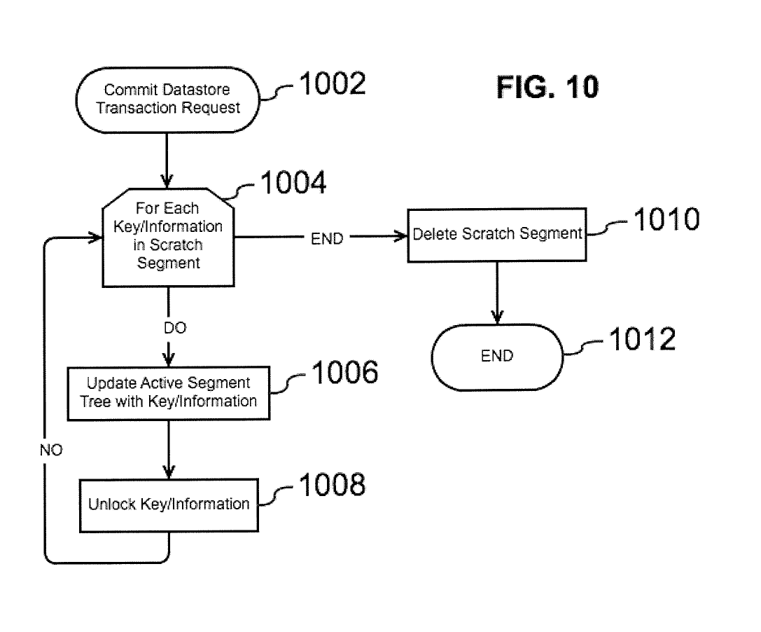

FIG. 6 is a flow chart illustrating aspects of an example automated method 600 of receiving a commit transaction request at 602 and then committing the transaction across all associated datastores starting at 604. At 606 a datastore transaction is committed, additional details are described in connection with FIG. 10, and if the transaction was not aborted as determined at 608 the next datastore is iterated over in 604. If the datastore transaction was aborted as determined at 608 the global transaction is aborted at 610, additional details are described in connection with FIG. 7, and an aborted status is returned at 618.

Once all ordered datastores are traversed at 604 their commit locks are released in acquisition order starting at 612. At 614 each datastore's commit lock is released and once all ordered datastores have been traversed the iteration over the datastores at 612 ends and a commit indication is written to the global transaction log at 616. Finally, a success status is returned at 618.

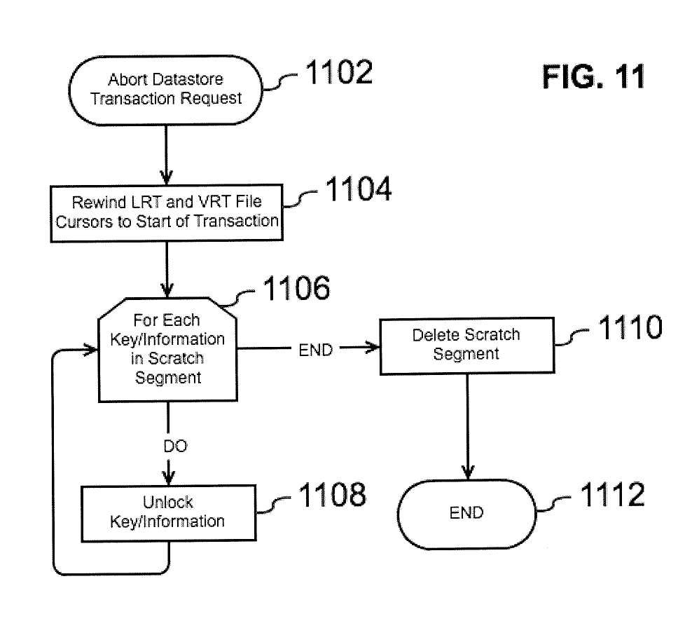

FIG. 7 is a flow chart illustrating aspects of an example automated method 700 of receiving an abort transaction request at 702 and then aborting the transaction starting at 704. Each ordered datastore comprising the transaction is iterated over staring at 704 and is aborted at 706, additional details are described in connection with FIG. 11. Once all datastores have been aborted the iteration is ended at 704, a new iteration over the ordered datastores is started at 708 and each datastore's commit lock is released at 710. After all datastore commit locks are released the iteration at 708 is ended, an abort indication is written to the global transaction log at 712 and the abort process ends at 714.

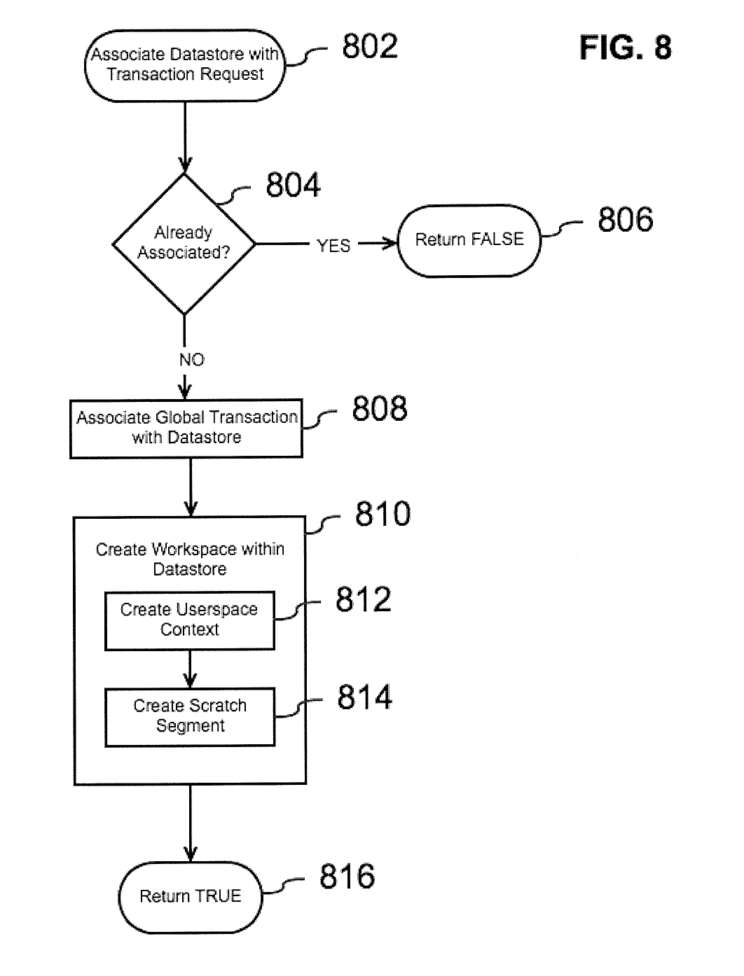

FIG. 8 is a flow chart illustrating aspects of an example automated method 800 of receiving an associate datastore with transaction request at 802 and associating a datastore with the transaction if it is not already associated with the transaction as determined at 804. If the datastore is already associated as determined at 804 FALSE is returned at 806. Otherwise, the global transaction is associated with the datastore at 808 and a workspace within the datastore is created at 810.

Creating a workspace within a datastore includes the creation of a userspace context at 812 and the creation of a scratch segment at 814. Once the workspace and its components have been created TRUE is returned at 816.

FIG. 9 is a flow chart illustrating aspects of an example automated method 900 of receiving a prepare datastore transaction request at 902 and preparing the datastore for transaction commit starting at 904. Preparing a datastore requires all state information (i.e. Key/Information pairs) present in the transaction's scratch segment to be written to non-transient storage. At 904 each Key/Information pair within the scratch segment is iterated over and the value element is written to the VRT file in 906. If the value element write fails as determined at 908 the datastore transaction is aborted at 914, additional details are described in connection with FIG. 11, and a failure status is returned at 916.

When the value element write succeeds as determined at 908 the associated key element is written to the LRT file at 910. If the key element write fails as determined at 912 the datastore transaction is aborted at 914, additional details are described in connection with FIG. 11, and a failure status is returned at 916.

A successful key element write continues with iteration over the next Key/Information pair at 904. Finally, once all Key/Information pairs have been successfully written the iteration process at 904 ends and a success status is returned at 916.

FIG. 10 is a flow chart illustrating aspects of an example automated method 1000 of receiving a commit datastore transaction request at 1002 and updating the in-memory state of the datastore. This may be accomplished by iterating over all Key/Information pairs in the transaction's scratch segment at 1004 and updating the active segment tree with the Key/Information pair at 1006. After the active segment tree is updated at 1006 the Key/Information pair is unlocked at 1008. Once all Key/Information pairs have been applied the iteration at 1004 ends, the scratch segment is deleted at 1010 and the commit process ends at 1012.

FIG. 11 is a flow chart illustrating aspects of an example automated method 1100 of receiving an abort datastore transaction request at 1102 and rewinding the datastore's LRT and VRT file write cursors to the start of the transaction at 1104. After the file write cursors have been rewound at 1104 each Key/Information in the transaction's scratch segment are iterated over in 1106 and unlocked at 1108. Once all Key/Information pairs in the scratch segment have been unlocked the iteration at 1106 ends, the scratch segment is deleted in 1110 and the abort process ends at 1112.

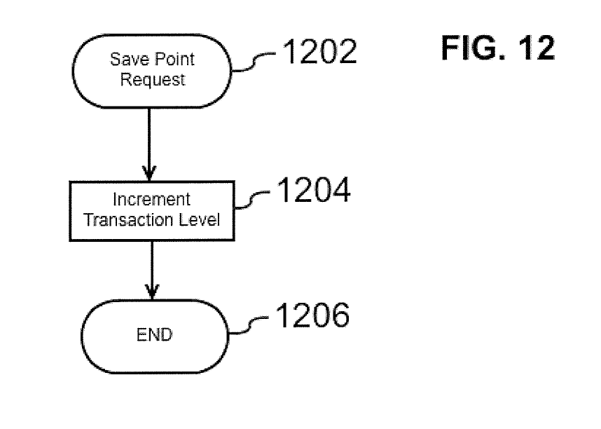

FIG. 12 is a flow chart illustrating aspects of an example automated method 1200 of receiving a save point request at 1202 and incrementing the transaction level at 1204. Each save point request increments the transaction level to enable transaction save points and transaction nesting. Once the transaction level has been incremented in 1204 the process ends at 1206.

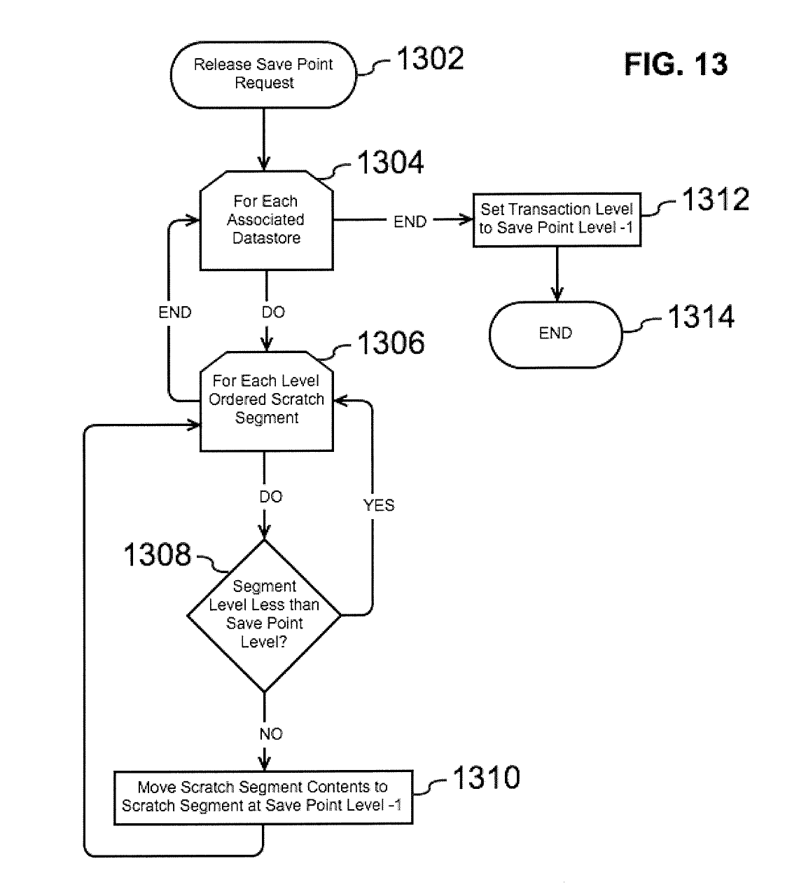

FIG. 13 is a flow chart illustrating aspects of an example automated method 1300 of receiving a release save point request at 1302 and releasing that save point within all associated datastores starting at 1304. Each associated datastore is iterated over in 1304 and each level ordered scratch segment within each datastore is iterated over in 1306. If the segment's level is less than the save point level as determined at 1308 the iteration continues at 1306. Otherwise, the segment's level is greater than or equal to the save point's level and the scratch segment's contents are moved to the scratch segment at save point level−1 at 1310. Thus, the state for all save points including and below the released save point is aggregated into the bottommost scratch segment.

Once all level ordered scratch segments are traversed in 1306 the next associated datastore is traversed in 1304. When datastore traversal is complete the current transaction level is set to the save point level−1 at 1312 and the process ends at 1314.

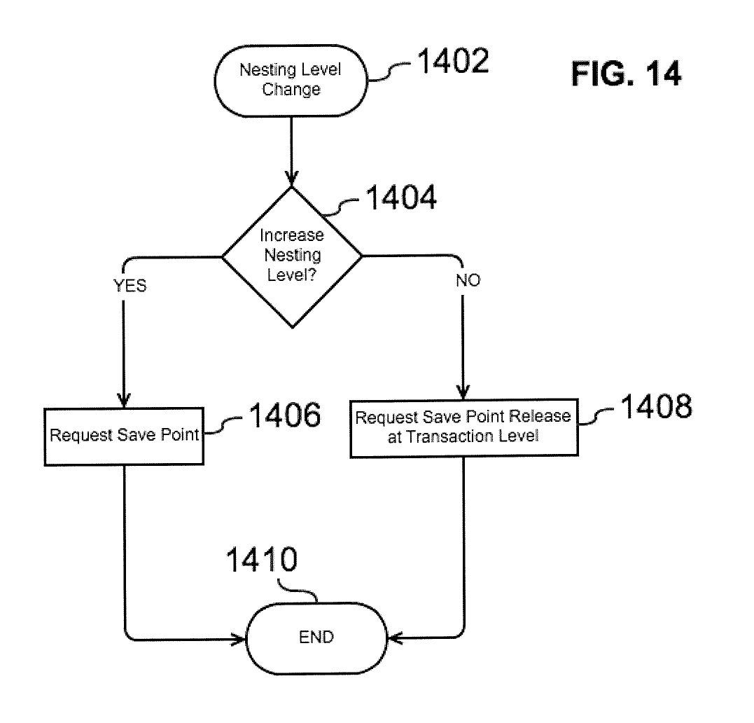

FIG. 14 is a flow chart illustrating aspects of an example automated method 1400 of processing a nesting level change indication received at 1402. If the nesting level is being increased as determined at 1404 a save point is requested at 1406, additional details are described in connection with FIG. 12, and the method ends at 1410. When the nesting level is being decreased as determined at 1404 the save point at the current transaction level is released at 1408, additional details are described in connection with FIG. 13, and the method ends at 1410.

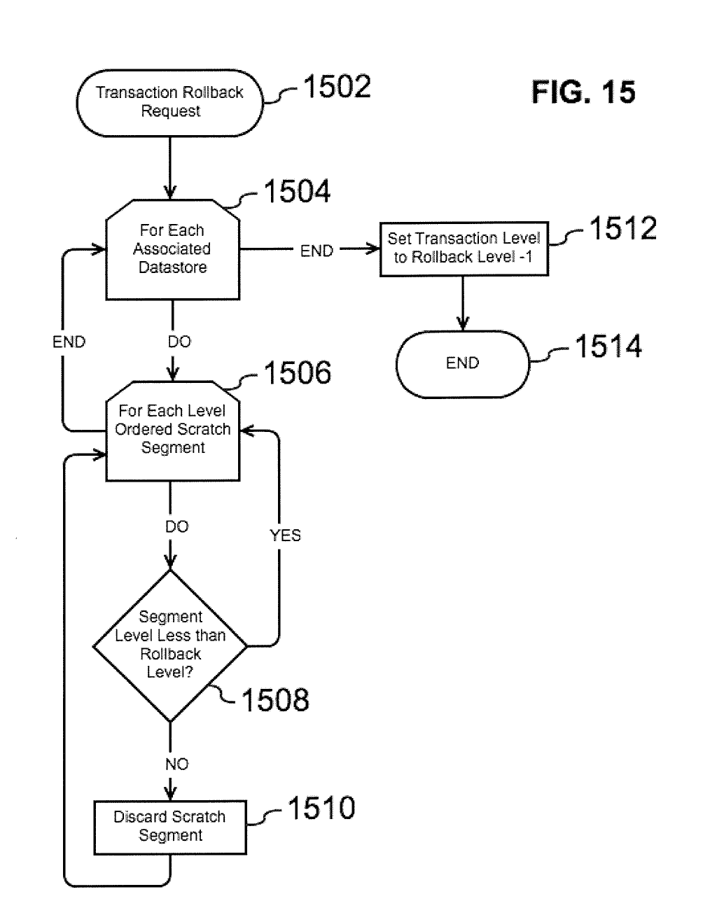

FIG. 15 is a flow chart illustrating aspects of an example automated method 1500 of receiving a transaction rollback request at 1502 and rolling back that transaction across all associated datastores starting at 1504. At 1504 each associated datastore is iterated over and then each level ordered scratch segment within each associated datastore is traversed in 1506. If the traversed scratch segment's level is less than the rollback level as determined at 1508, the next ordered scratch segment is iterated over in 1506. When the scratch segment's level is greater than or equal to the rollback level as determined at 1508 the scratch segment is discarded at 1510 and the iteration continues at 1506.

Once all scratch segments have been iterated over in 1506 the next associated datastore is iterated over in 1504. When all associated datastores have been iterated over the transaction level is set to the rollback level−1 in 1512 and the method ends at 1514.

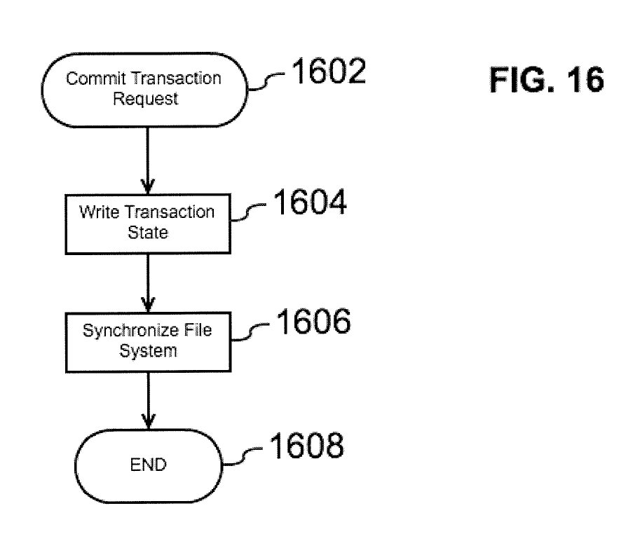

FIG. 16 is a flow chart illustrating aspects of an example automated method 1600 of receiving a commit transaction request at 1602 and processing that request when transaction streamlining with synchronous IO is enabled. After receiving the commit transaction request at 1602 the transaction's state is written in 1604, the file system is synchronized in 1606 and the method ends at 1608.

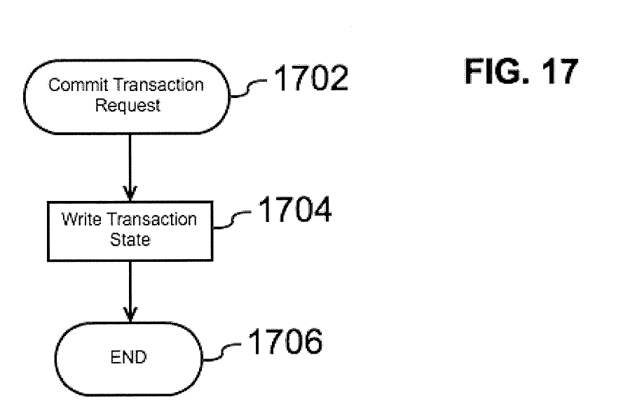

FIG. 17 is a flow chart illustrating aspects of an example automated method 1700 of receiving a commit transaction request at 1702 and processing that request when transaction streamlining with asynchronous IO is enabled. After receiving the commit transaction request at 1702 the transaction's state is written in 1704 and the method ends at 1706.

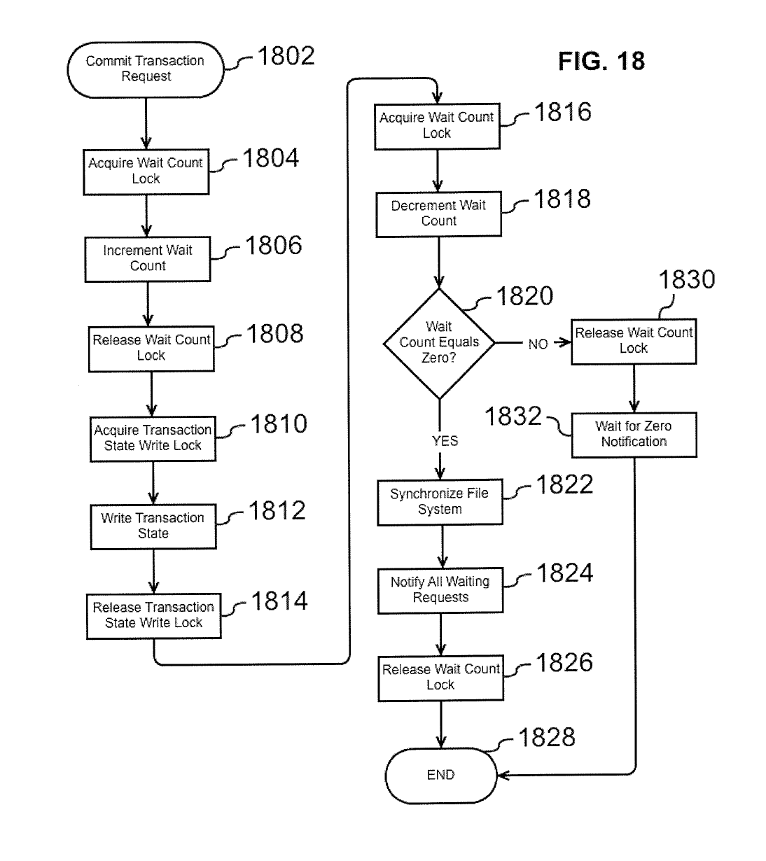

FIG. 18 is a flow chart illustrating aspects of an example automated method 1800 of receiving a commit transaction request at 1802 and processing that request when transaction pipelining with synchronous IO is enabled. After receiving the coming transaction request in 1802 the wait count lock is acquired in 1804, the wait count is incremented in 1806 and the wait count lock is released in 1808. Next, the transaction state write lock is acquired in 1810, the transaction state is written in 1812 and the transaction state write lock is released in 1814.

Once the transaction's state has been written and the write lock released the wait count lock is acquired in 1816 and the wait count is decremented in 1818. If the wait count is non-zero as determined by 1820 the method releases the wait count lock at 1830 and waits for zero notification in 1832. When a zero notification occurs at 1830 the method ends at 1828.

If the wait count is equal to zero at 1820 the file system is synchronized in 1822 and all waiting requests are notified of zero in 1824. Finally, the wait count lock is released at 1826 and the method ends at 1828.

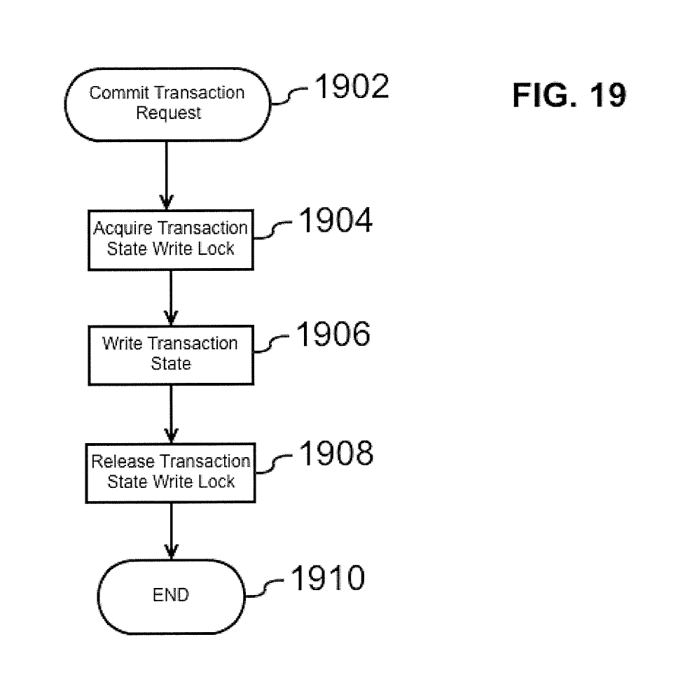

FIG. 19 is a flow chart illustrating aspects of an example automated method 1900 of receiving a commit transaction request at 1902 and processing that request when transaction pipelining with asynchronous IO is enabled. After receiving the commit transaction request at 1902 the transaction state write lock is acquired at 1904 and the transaction state is written at 1906. Once the transaction state is written the transaction state write lock is released at 1908 and the method ends at 1910.

Thus, in accordance with aspects presented herein, transactions can group operations into atomic, isolated, and serialize-able units. There may be two major types of transactions, e.g., transactions within a single datastore and transactions spanning datastores. Transactions may be formed in-memory, e.g., with a disk cache for large transactions, and may be flushed to disk upon commit. Thus, information in LRT, VRT, and IRT files may represent commit transactions rather than intermediate results.

Once a transaction is committed to disk, the in-memory components of the datastore, e.g., the active segment tree, may be updated as necessary. In one example, committing to disk first, and then applying changes to the shared in-memory representation while holding the transaction's locks may enforce transactional semantics. All locks associated with the transaction may be removed, e.g., once the shared in-memory representation is updated.

Transactions may be formed in-memory before they are either committed or rolled-back. Isolation may be maintained by ensuring transactions in process do not modify shared memory, e.g., the active segment tree, until the transactions are successfully committed.

Global, e.g., database, transactions may span one to many datastores. Global transactions may coordinate an over-arching transaction with datastore level transactions. Global transactions may span both local datastores and distributed datastores. Architecturally, transactions spanning datastores may have the same semantics. This may be accomplished through the use of an atomic commitment protocol for both local and distributed transactions. More specifically, an enhanced two-phase commit protocol may be used.

All database transactions may be given a Universally Unique Identifier (UUID) that enables them to be uniquely identified without the need for distributed ID coordination, e.g., a Type 4 UUID. This transaction UUID may be carried between systems participating in the distributed transaction and may be stored, e.g., in transaction logs.

When a transaction spanning multiple datastores is committed, the global transaction log for those distributions may be maintained, e.g., in two phases—a prepare phase and a commit phase. FIG. 20 illustrates aspects of an example two-phase commit Finite Sate Machine (FSM).

As illustrated in FIG. 20, when a transaction spanning multiple datastores is committed, an update of the global transaction log may be initiated, e.g., with a begin transaction prepare record. The begin transaction prepare record may comprise, e.g., the global transaction ID and a size (e.g., number) of affected datastores. This record may then be followed by additional records. Such additional records may include, among other information, an indication of the datastore UUIDs and their start of transaction positions.

Each datastore has a commit lock that may be acquired during the prepare phase and before the transaction log is updated with the global transaction ID or the datastore UUIDs of the attached datastores. The datastore commit locks may be acquired in a consistent order, e.g., to avoid the possibility of a deadlock. Once the commit locks are acquired and the prepare records are written to the global transaction log, the transaction may proceed, e.g., with prepare calls on each datastore comprised in the transaction. The datastore prepare phase may comprise writing the LRT/VRT files with the key/values comprised in their scratch segments. Once each datastore has been successfully prepared, the transaction moves to the commit phase.

During a transaction commit phase, a commit may be called on each of the datastores comprised in the transaction, releasing each datastore's commit lock. Then, the global transaction log may be updated with a commit record for the transaction. The commit record may comprise any of a commit flag set, a global transaction UUID, and a pointer to the start of a transaction record within the global transaction log file.

If any of the datastores comprised in the transaction cane be prepared during the prepare phase, an abort is performed. This may occur, e.g., when a write fails. An abort may be applied to roll back all written transaction information in each datastore comprised in the transaction. As described supra the start of each transaction position within each datastore may be written to the global transaction log during the prepare phase while holding all associated datastore commit locks. This may enable a rollback to be as simple as rewinding each LRT/VRT file insertion point for the transaction to the transaction's start location. At times, it may be desirable to preserve append-only operation and to have erasure code appended to the affected LRT/VRT files. Holding commit locks, e.g., may enable each LRT/VRT file to be written to by only one transaction at a time. An abort record for the transaction may then be appended to the global transaction log.

In an aspect, transactions within a datastore may be localized to and managed by that datastore. In such an aspect, transactions within the datastore may be initiated by a request to associate the datastore with a global transaction. An associated transaction request on a datastore may, e.g., create an internal workspace within the datastore. This may occur, e.g., for a new association. When a new association is created, a first indication may be returned. When the transaction was previously associated within the datastore, a second indication may be returned. For example, the first indication may comprise a “true” indication, while the second indication comprises a “false” indication. When a false indication is returned, e.g., and the existing workspace is used internally, at least one workspace object may maintain the context for all operations performed within a transaction on the datastore. A workspace may comprise a user space context and a scratch segment maintaining key to information bindings. Such a scratch segment may maintain a consolidated record of all last changes performed within the transaction. The record may be consolidated, e.g., because it may be a key to information structure where information comprises the last value change for a key. As a transaction progresses, the keys it accesses and the values that it modifies may be recorded in the workspace's segment.

Among others, there may be, e.g., four key/value access/update circumstances. First, such circumstances may include “created” indicating the transaction that created the key/value. Second, such circumstances may include “read” indicating a transaction that read the key/value. Third, such circumstances may include “updated” indicating a transaction that updated the key/value. Fourth, such circumstances may include “deleted” indicating a transaction that deleted the key/value.

Once a transaction access and/or updates a key/value, all subsequent accesses and/or updates for that key/value may be performed on the workspace's scratch segment. For example, it may be isolated from the active segment tree.

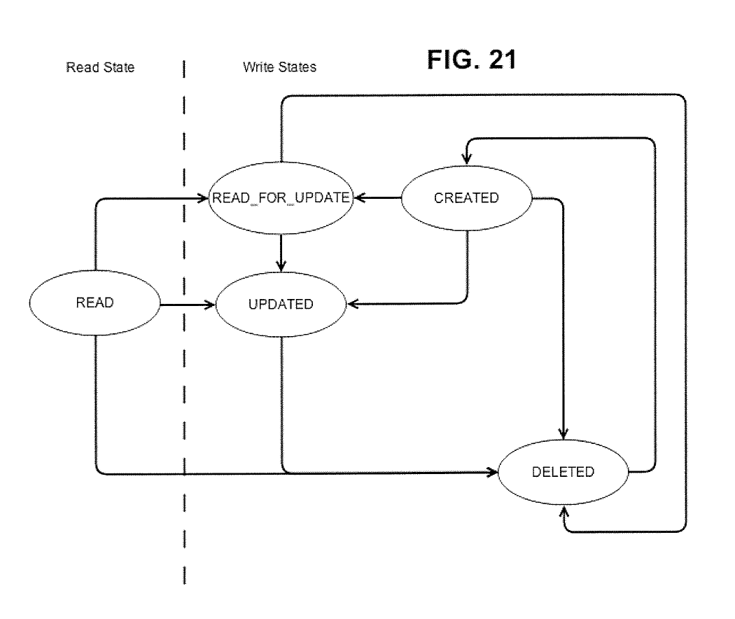

FIG. 21 illustrates aspects of example valid key/value state transitions within a single transaction. FIG. 21 illustrates, e.g., the created, read, updated, and deleted transitions that may occur for a key/value. Maintaining the correct state for each entry may require appropriate lock acquisition and maintenance. The read state may, e.g., minimally require a read lock acquisition, whereas the created, read-for-update, updated, and deleted states may require write lock acquisition. A single owner read lock may be promoted, e.g., to a write lock. However, once a write request, e.g., a read-for-update, or a write, e.g., create, update, or delete, occurs, write locks may not be demoted to read locks.

Locks may exist at both the active segment level and at the key/value level. Adding a new key/value to a segment may require an acquisition of a segment lock, e.g., for the segment that is being modified. This may further require the creation of a placeholder information objected within the active segment tree. Once an information object exists, it may be used for key/value level locking and state bookkeeping.

Lock coupling may be used to obtain top-level segment locks. Lightweight two phase locking may then be used for segment and information locking. Two phase locking implies all locks for a transaction may be acquired and held for the duration of the transaction. Locks may be released e.g., only after no further information will be accessed. For example, locks may be released at a commit or an abort.

State bookkeeping enables the detection of transaction collisions and deadlocks. Many transactions may read the same key/value. However, only one transaction may write a key/value at a time. Furthermore, once a key/value has been read in a transaction, it may not change during that transaction. If a second transaction attempts to write the key/value that a first transaction has read or written, a transaction collision is considered to have occurred. Such transaction collisions should be avoided, when possible. When avoidance may not be possible, it may be important to detect and resolve such collisions. Collision resolution may include, e.g., any of blocking on locks to coordinate key/value access; deadlock detection, avoidance, and recovery; and error reporting and transaction roll back.

During a prepare phase, when a datastore level transaction is prepared, its workspace's scratch segment may be written to a disk VRT file first and then to an LRT file.

During a commit phase, a successfully written transaction may be committed. When such a transaction is committed, any of (1) the active segment tree may be updated with the information in the workspace's scratch segment, (2) associated bookkeeping may be updated, and (3) all acquired locks may be released.

When an unsuccessful transaction is aborted and rolled back, any of (1) associated bookkeeping may be updated, (2) the LRT and VRT file pointers may be reset to the transaction start location, (3) all acquired locks may be released, (4) the workspace's scratch segment may be discarded, and (4) transaction error reporting may be performed. In order to reset the LRT and VRT file pointers to the transaction start location, e.g., the file lengths may be set to the transaction start location.

Transactions may be written to on-disk representation. Transactions written to disk may be delimited on disk to enable error detection and correction. Transaction delineation may be performed both within and between datastores. For example, group delimiters may identify transactions within datastore files. An append-only transaction log, e.g., referencing the transaction's groups within each datastore, may identify transactions between datastores. A datastore's LRT file may delimit groups using, e.g., a group start flag and a group end flag.

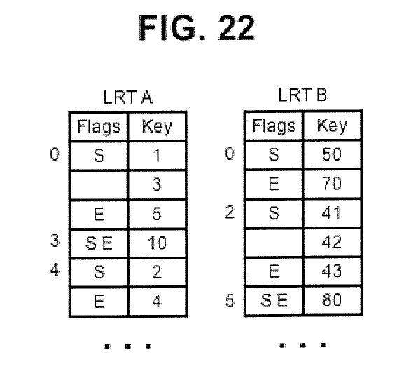

FIG. 22 illustrates aspects of an example group delineation in LRT files. Three group operations are illustrated in each of LRT file A and LRT file B in FIG. 22. In LRT A, the first group operation involves keys 1, 3, and 5. The second operation only affected key 10, and the third operation affected keys 2 and 4. The indexes for the example group operations in LRT A are 0, 3, and 4. Each group operation may be indicated as

Index=>tuple of affected keys

Using this notation, LRT B has three group operations, 0=>(50, 70), 2=>(41, 42, and 43) and 5=>(80).

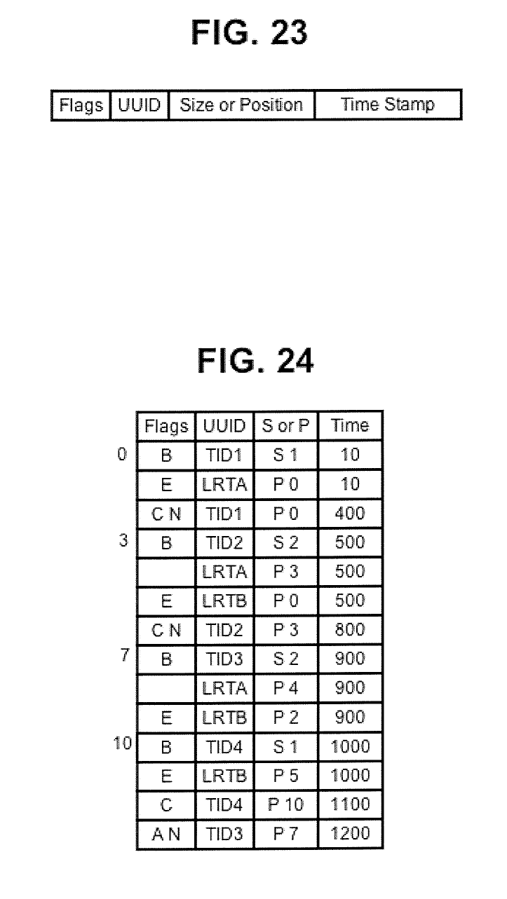

A transaction log may comprise, e.g., entries identifying each of the components of the transaction. FIG. 23 illustrates aspects of an example logical layout of a transaction log entry.

Flags may indicate, among other information, any of a begin prepare transaction, an end prepare transaction, a commit transaction, an abort transaction, and no outstanding transactions.

When a begin transaction is set, e.g., a UUID may be the transaction's ID and the size of the transaction may be specified, as illustrated in FIG. 23. After the begin transaction, including the end transaction entry, the UUID may be the file UUID where the transaction group was written. When a file UUID is written, position may indicate the group start offset into that file.

When a committed transaction flag is set, UUID may be the committed transaction's UUID and the position may indicate a position of the begin transaction record within the transaction log.

When an aborted transaction flag is set, the UUID may be the aborted transaction's UUID and the position may indicate a position of the begin transaction record within the transaction log. This may be the same scheme, e.g., as a scheme applied when a transaction is committed.

The no outstanding transactions flag may be set, e.g., during commit or abort when there are no outstanding transactions left to commit or abort. This may act as a checkpoint flag, enabling error recovery to quickly converge when this flag is set. For example, error recover may stop searching for transaction pairings once this flag is encountered.

Time stamp may record the time in ticks, or wall clock time when the operation occurred. Among others, tick may be recorded via a lamport timestamp. Wall clock time may indicate, e.g., milliseconds since the epoch.

FIG. 24 illustrates aspects of an example transaction log spanning two files, e.g., LRTA and LRTB. A transaction log may provide an ordered record of all transactions across datastores. The transaction log may provide error detection and enable correction, e.g., for transactions spanning data stores.

Errors may occur in any of the files of the datastore. A common error may comprise an incomplete write. This error damages the last record in a file. When this occurs, affected transactions may be detected and rolled back. For example, such affected transactions may comprise transactions within a single datastore or transactions spanning multiple datastores. Error detection and correction within a datastore may provide the last valid group operation position within its LRT file. Given this LRT position, any transaction within the transaction log after this position may be rolled back, e.g., as the data for the transaction may have been lost. If the data for the transaction spans multiple datastores, the transaction may be rolled back across datastores. In this aspect, the transaction log may indicate the datastores to be rolled back. For example, the transaction log may indicate the datastores to be rolled back by file UUID and position.

A transaction in progress may have, e.g., named save points. Save points may enable a transaction to roll back to a previous save point without aborting the entire transaction. Additionally, save points can be released and their changes can be aggregated to an enclosing save point or to a transaction context.

Nested transactions may have, e.g., implicit save points. When a nested transaction is rolled back, the operations and state of the nested transaction may be rolled back. For example, this may not roll back the entire enclosing transaction. A rollback all operation may enable the rollback of all transactions comprised with the nested transaction.

Streamlined transactions may have any of the following features: (1) single-threaded, (2) zero-copy, (3) single-buffered, and (4) minimal per-transaction latency.

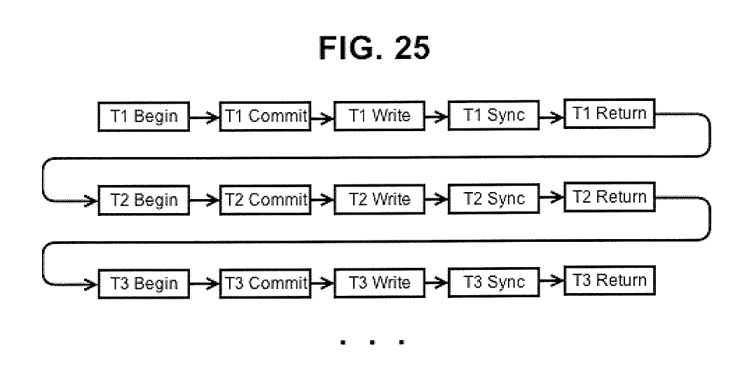

When a transaction is committed and synchronous durability is desired, the commit operation may be configured to not return until after the transaction's state is written to persistent storage. When transactions are streamlined, this implies that a Sync may be performed after every transaction write. This approach may have a large performance impact. FIG. 25 illustrates aspects of an example transaction streamlining with synchronous input/output (IO).

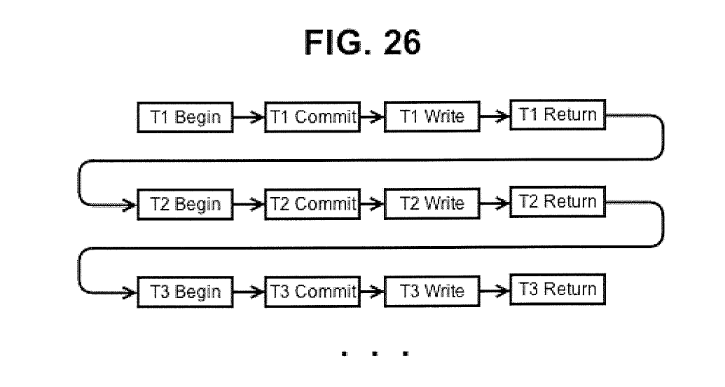

Asynchronous IO may provide better performance when transactions are streamlined. When this mode is used, transaction writes may not force synchronization with the file system. FIG. 26 illustrates aspects of an example transaction streamlined with asynchronous IO.

Pipelined transactions may comprise any of a multi-threaded, a double-buffered, providing maximal throughput, and adding latency to overlapping commits when synchronous IO is used. When a transaction is committed and synchronous durability is desired, the commit operation may be configured to not return until after the transaction's state is written to persistent storage. This may require, e.g., a Sync operation to force information out of memory buffers and on to persistent storage.

One approach may involve a Sync operation immediately after each commit operation. However, this approach might not scale well and may reduce system throughput. Thus, another approach may comprise transaction pipelining. This approach may be applied to transactions that overlap in time. Commits may be serialized, but may be configured to not return until there is a Sync operation. At that time, all pending commits may return. Using this approach, the cost of the Sync operation may be amortized over many transactions. Thus, individual transaction commits may not return, e.g., until a transaction state is written to persistent storage. Such transaction pipelining may comprise either synchronous IO or asynchronous IO.

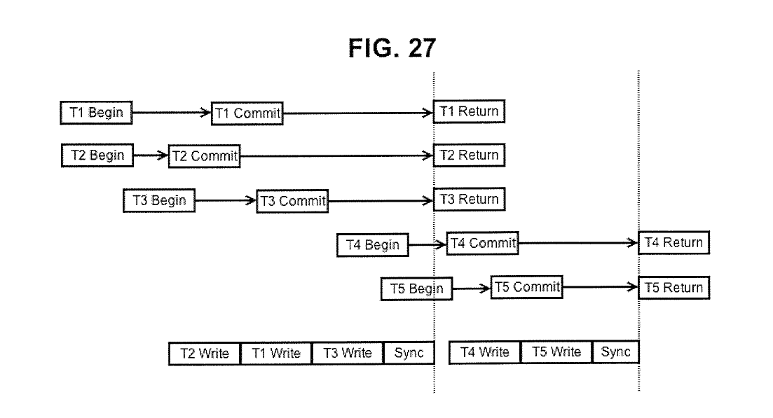

FIG. 27 illustrates aspects of an example transaction pipelining with synchronous IO.

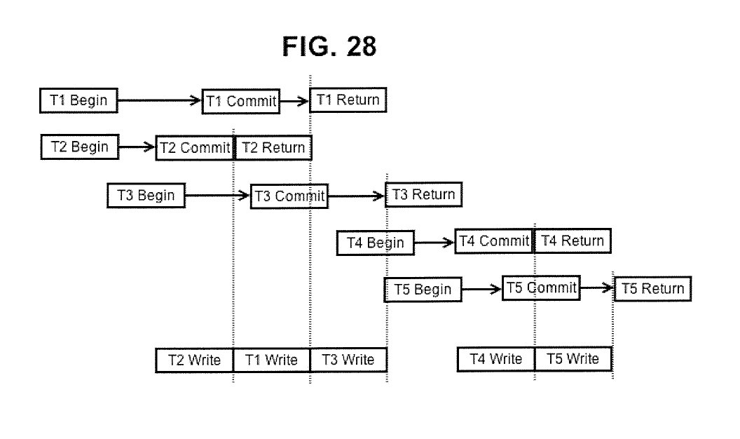

In an alternate aspect, asynchronous IO may enable a transaction to be buffered at both the application and operating system layers. Each commit may return, e.g., as soon as the transaction's data is written to write buffers. FIG. 28 illustrates aspects of example transaction pipelining with asynchronous IO.

While aspects of this invention have been described in conjunction with the example aspects of implementations outlined above, various alternatives, modifications, variations, improvements, and/or substantial equivalents, whether known or that are or may be presently unforeseen, may become apparent to those having at least ordinary skill in the art. Accordingly, the example illustrations, as set forth above, are intended to be illustrative, not limiting. Various changes may be made without departing from the spirit and scope hereof. Therefore, aspects of the invention are intended to embrace all known or later-developed alternatives, modifications, variations, improvements, and/or substantial equivalents.

What is claimed is:

1. A computer assisted method for transaction representation in append-only data-stores, the method including:
receiving input from at least one of a user and an agent;
beginning a transaction involving at least one datastore based on the received input;
at least one selected from a group consisting of creating, updating and maintaining a transaction state;
ending the transaction; and
writing the state of the transaction to memory in an append-only manner, wherein the state comprises append-only key and value files.

2. The method of claim 1, wherein the append-only key and values files encode at least one boundary that represents the transaction.

3. The method of claim 2, wherein append-only transaction log files group a plurality of files representing the transaction.

4. The method of claim 1, wherein the append-only key and values files represent an end state of the transaction.

5. The method of claim 4, wherein the memory comprises disk memory.

6. The method of claim 1, wherein beginning a transaction includes accessing at least one key/value pair within a datastore.

7. The method of claim 6, further comprising:
creating a workspace comprising a user space context and a scratch segment maintaining key to information bindings; and
maintaining transaction levels.

8. The method of claim 7, further comprising:
copying a state of the at least one datastore involved in the transaction from memory into the scratch segment.

9. The method of claim 8, further comprising:
updating the scratch segment throughout the transaction.

10. The method of claim 9, wherein the state written to memory comprises an end state of the scratch segment after the transaction has ended.

11. The method of claim 6, further comprising at least one selected from a group consisting of:
acquiring a lock for a segment involved in the transaction;
acquiring a read lock for a key/value pair read in the transaction; and
acquiring a write lock for a key/value pair modified in the transaction.

12. The method of claim 11, wherein ending the transaction includes releasing any acquired locks.

13. The method of claim 12, wherein ending the transaction includes releasing the acquired locks in lock acquisition order.

14. The method of claim 11, wherein a key/value pair is considered modified when the key/value pair when at least one selected from a group consisting of creation, update, and modification is performed for the key/value pair.

15. The method of claim 11, wherein a read lock is promoted to a write lock when only one reader holds the read lock and in order to enable the reader to modify key/value pairs.

16. The method of claim 11, wherein locks are acquired in order and lock acquisition order is maintained.

17. The method of claim 1, further comprising:
preparing at least one datastore involved in the transaction.

18. The method of claim 17, further comprising:
appending a begin prepare transaction indication to the global transaction log when the prepare begins;
acquiring a prepare lock for each datastore involved in the transaction; and
appending an end prepare transaction indication to the global transaction log when the prepare ends.

19. The method of claim 18, wherein datastore prepare locks are acquired in a consistent order to avoid deadlocks.

20. The method of claim 18, wherein the begin prepare transaction indication and the end prepare transaction indication identify the transaction being prepared.

21. The method of claim 17, wherein the transaction state is written to each datastore in an append-only manner after all datastore prepare locks have been acquired.

22. The method of claim 21, wherein transactional value state (VRT) files are appended before transactional log state (LRTs) files are appended.

23. The method of claim 1, further comprising:
aborting the transaction.

24. The method of claim 23, wherein during the prepare state all associated prepare locks are released in a consistent acquisition order.

25. The method of claim 24, wherein the transaction state is written to at least one of a transactional value (VRT) file and a transactional log state (LRT) file, wherein the transaction state is either rolled back or identified with an append-only erasure indication.

26. The method of claim 24, wherein an abort transaction indication is appended to a global transaction log, the abort transaction indication indicating the transaction aborted.

27. The method of claim 23, wherein aborting the transaction includes releasing any acquired segment and key/value locks in acquisition order.

28. The method of claim 1, further comprising:
committing the transaction.

29. The method of claim 28, wherein committing the transaction causes the transaction to be prepared and follows successful transaction preparation.

30. The method of claim 28, wherein a commit transaction indication is appended to a global transaction log, the commit transaction indication indicating the transaction committed.

31. The method of claim 28, wherein committing the transaction includes releasing any acquired segment and key/value locks in acquisition order.

32. The method of claim 1, further comprising:
performing the transaction in one of a streamlined and a pipelined manner.

33. The method of claim 32, wherein input/output (IO) is synchronous.

34. The method of claim 32, wherein input/output (IO) is asynchronous.

35. The method of claim 32, wherein transaction streamlining comprises a single-threaded, zero-copy, single-buffered method.

36. The method of claim 32, wherein transaction streamlining minimizes per-transaction latency.

37. The method of claim 32, wherein transaction pipelining comprises a multi-threaded, double-buffered method.

38. The method of claim 32, wherein transaction pipelining maximizes transaction throughput.

39. The method of claim 1, wherein transactions are identified by Universally Unique Identifiers (UUIDs).

40. The method of claim 1, wherein transactions are distributed.

41. The method of claim 1, further comprising:
using a global append-only transaction log file.

42. The method of claim 41, wherein at least one flag indicates a transaction state, and wherein the at least one flag represents at least one selected from a group consisting of a begin prepare transaction, an end prepare transaction, a commit transaction, an abort transaction, and no outstanding transactions.

43. The method of claim 42, wherein a no outstanding transactions flag is used as a checkpoint enabling fast convergence of error recovery algorithms.

44. The method of claim 41, wherein transactions and files are identified by Universally Unique Identifiers (UUIDs).

45. The method of claim 41, wherein a time stamp records a transaction time.

46. The method of claim 45, wherein the time stamp comprises one of wall clock time and time measured in ticks.

47. The method of claim 1, wherein creating, updating, and maintaining the transaction state includes using transaction save points, transaction restore points, and transaction nesting.

48. The method of claim 47, wherein transaction save points enable a transaction to roll back operations to any save point without aborting the entire transaction.

49. The method of claim 47, wherein transaction save points can be released with their changes being preserved.

50. The method of claim 47, wherein transaction nesting creates implicit save points.

51. The method of claim 50, wherein rolling back a nested transaction does not roll back the nesting transaction.

52. The method of claim 50, wherein a rollback all operation rolls back both nested and nesting transactions.

53. An automated system for transaction representation in append-only data-stores, the system comprising:
means for receiving input from at least one selected from a group consisting of a user and an agent;
means for beginning a transaction involving at least one datastore based on the user or agent input;
means for at least one selected from a group consisting of creating, updating and maintaining a transaction state;
means for ending the transaction; and
means for writing the state of the transaction to memory in an append-only manner, wherein the state comprises append-only key and value files.

54. A computer program product comprising a computer readable medium having control logic stored therein for causing a computer to perform transaction representation in append-only data-stores, the control logic code for:
receiving input from at least one selected from a group consisting of a user and an agent;
beginning a transaction involving at least one datastore based on the user or agent input;
at least one selected from a group consisting of creating, updating, and maintaining a transaction state;
ending the transaction; and
writing the state of the transaction to memory in an append-only manner, wherein the state comprises append-only key and value files.

55. An automated system for transaction representation in append-only data-stores, the system comprising:
at least one processor;
a user interface functioning via the at least one processor, wherein the user interface is configured to receive a user input; and
a repository accessible by the at least one processor; wherein the at least one processor is configured to:
begin a transaction involving at least one datastore based on the user input;
at least one selected from a group consisting of create, update, and maintaining a transaction state;
end the transaction; and
write the state of the transaction to memory in an append-only manner, wherein the state comprises append-only key and value files.
